(19) United States
(12) Patent Application Publication
(10) Pub. No.: US 2014/0279541 A1
(43) Pub. Date: Sep. 18, 2014

(54) VAULT PLATFORM METHODS, APPARATUSES AND MEDIA

(71) Applicant: Merchantwarehouse.com, LLC, Boston, MA (US)

(72) Inventors: Marc Castrechini, Easton, MA (US); Markiyan Malko, Melrose, MA (US); Henry Helgeson, Boston, MA (US)

(73) Assignee: Merchantwarehouse.com, LLC, Boston, MA (US)

(21) Appl. No.: 14/211,806

(22) Filed: Mar. 14, 2014

Related U.S. Application Data
(60) Provisional application No. 61/787,176, filed on Mar. 15, 2013.

(51) Int. Cl. G06Q 20/32; G06Q 20/38

(52) U.S. Cl. CPC G06Q 20/3274; G06Q 20/385
USPC 705/44

(57) ABSTRACT

A payment token request may be obtained from a customer's smartphone. A payment token associated with the customer's account may be generated and sent to the customer's smartphone. A payment request including the payment token may be obtained from a consumer engagement device (CED). Payment information associated with the customer's account may be retrieved based on the payment token. Payment for the payment request may be authorized and a payment confirmation may be sent to the CED.

### PRIORITY

The application claims priority to and the benefit of U.S. Provisional Patent Application No. 61/787,176, filed Mar. 15, 2013, the text of which is incorporated herein by reference in its entirety.

This disclosure describes VAULT PLATFORM METHODS, APPARATUSES AND MEDIA (hereinafter “VP”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### FIELD

The present disclosure is directed generally to payment processing and customer engagement platforms.

### BACKGROUND

Cash and electronic payment methods that do not involve physical currency (e.g., credit cards and debit cards) are popular with both customers and merchants. In a typical transaction, a customer may utilize cash or an electronic payment card to purchase items (e.g., goods and/or services) from a merchant. Accordingly, customers typically carry cash and/or an electronic payment card to pay for their purchases.

### BRIEF DESCRIPTION OF THE FIGURES

The accompanying figures and/or appendices illustrate various exemplary embodiments in accordance with the present disclosure.

FIG. 1 shows an exemplary usage scenario in one embodiment of the VP.

FIG. 2 shows a screen shot diagram illustrating an exemplary customer engagement device (CED) in one embodiment of the VP.

FIG. 3 shows a screen shot diagram illustrating an exemplary mobile app in one embodiment of the VP.

FIG. 4 shows a transaction processing data flow diagram in one embodiment of the VP.

FIG. 5 shows a logic flow diagram illustrating a VP mobile app transaction processing (MATP) component in one embodiment of the VP.

FIG. 6 shows a logic flow diagram illustrating a server transaction processing (STP) component in one embodiment of the VP.

FIG. 7 shows a logic flow diagram illustrating a CED transaction processing (CTP) component in one embodiment of the VP.

FIG. 8 shows a logic flow diagram illustrating an app registration (AR) component in one embodiment of the VP.

FIG. 9 shows a block diagram illustrating an exemplary VP coordinator in one embodiment of the VP.

FIG. 10 illustrates additional exemplary embodiments of the VP.

### DETAILED DESCRIPTION

### Introduction

In certain situations, people find it inconvenient to carry cash and/or electronic payment cards (e.g., credit cards, debit cards). For example, a person who is going to the gym may typically carry keys and a mobile device (e.g., a smartphone, a media player), but may not typically carry a wallet (e.g., out of concern that the wallet may be stolen and/or because it is inconvenient) with cash and/or electronic payment cards. Accordingly, such a person may not be able to purchase items (e.g., goods and/or services) at the gym because the person may not have a way to pay for a purchase.

The VP facilitates customer purchases of items by allowing customers to pay for items without having to carry cash or electronic payment cards. A customer may register for a merchant's (e.g., a gym's) VP mobile app and provide payment information (e.g., credit card information) regarding a payment method that the customer wishes to use (e.g., when purchasing items from the merchant). Such payment information may be specific to the merchant, or it may be shared and used by the customer in VP mobile apps of other merchants. When the customer wishes to purchase an item (e.g., a soda from the gym's vending machine, a personal training session), the customer may use the merchant's VP mobile app to request a payment token (e.g., a QR code). The customer may utilize the customer's mobile device to transmit (e.g., hold the QR code displayed on the mobile device's screen in front of the vending machine CED's camera, in front of a POS system's barcode reader, in front of a POS mobile device's camera) the payment token to the merchant's CED, POS system, mobile device with POS software, and/or the like. The VP may facilitate retrieving the customer's registered payment information using the QR code and processing the purchase transaction using the retrieved payment information.

### Detailed Description of the VP

FIG. 1 shows an exemplary usage scenario in one embodiment of the VP. In FIG. 1, a customer 102 may be thirsty after playing basketball at a gym. The customer may wish to purchase a soda sold at the gym, but may not have brought a wallet. Accordingly, the customer may wish to utilize the VP to purchase the soda.

The gym may have a vending machine with a CED 106. In various implementations, the CED may be integrated into the vending machine and/or may be communicatively coupled to the vending machine. The customer may utilize the gym's VP mobile app via the customer's client (e.g., a smartphone, a media player) to purchase the soda. In one embodiment, the customer may utilize the gym's VP mobile app to obtain a payment token, such as a QR code, from a vault platform server (VP Server) 110. The payment token may be generated by the VP Server for the purchase transaction and may be associated with the payment information provided by the customer for the gym's VP mobile app (e.g., when the customer registered with the gym's VP mobile app).

The gym's VP mobile app may display the QR code on the smartphone's screen, and the customer may transmit the QR code by holding the smartphone's screen in front of the CED's camera. The CED may send the QR code to the VP Server for verification that the QR code is valid and for authorization of the purchase transaction.

The VP Server may analyze the QR code and may retrieve the payment information provided by the customer for the gym's VP mobile app. The VP Server may authorize the purchase transaction (e.g., via an authorization request to a payment processor) and may inform the CED whether purchase was approved. If the purchase was approved, the CED may instruct the vending machine to dispense the customer's soda.

FIG. 2 shows a screen shot diagram illustrating an exemplary customer engagement device (CED) in one embodiment of the VP. In one embodiment, utilizing the CED to let the customer input payment information may result in improved security as a merchant's point of sale (POS) system, the merchant's servers, and the merchant's cashiers do not have access to a customer's payment information. In another embodiment, by utilizing the CED a merchant may gain the ability to accept new payment methods without having to make changes to the merchant's POS system. In yet another embodiment, utilizing the CED may facilitate delivery of promotional information (e.g., advertisements, coupons) to customers. FIG. 2 provides an example of how the CED may be utilized during a purchase transaction. In FIG. 2, screen 201 shows that a customer who wishes to purchase an item (e.g., a soda from a vending machine, a movie ticket) from a merchant (e.g., a gym, a movie theater) may be prompted to select a payment method 203. The customer may be presented with a variety of payment methods that the customer may choose. For example, the payment methods may include paying via the gym's VP mobile app 205A, via a credit card 205B, via PayPal 205C, and/or the like. The customer may also be presented with additional information. For example, such additional information may include the merchant's brand name (e.g., GYM), promotional information (e.g., advertisements, coupons), and/or the like.

Screen 210 show that if the customer selects the gym's VP mobile app 205A as the payment method, the CED may obtain a payment token from the customer (e.g., via the CED's camera, via the CED's barcode scanner) and may contact a VP Server (e.g., via a network connection) to obtain authorization for the purchase transaction 213.

Screen 220 shows the case in which the customer has multiple payment methods associated with the gym's VP mobile app. In this case, the customer may be prompted to select an associated payment method that should be used for the purchase transaction 223. For example, the customer may choose to pay via an Automated Clearing House (ACH) direct debit transfer 225A (e.g., the customer's selection) or via a credit card 225B.

Screen 230 shows that the CED may contact the VP Server to inform the VP Server regarding which payment method was selected and to obtain authorization for the purchase transaction. If the purchase transaction is authorized, the CED may instruct the vending machine to dispense the customer's soda and may remind the customer to take the soda 233. The customer may also be presented with additional information (e.g., informational messages from the merchant, coupons, advertisements).

FIG. 3 shows a screen shot diagram illustrating an exemplary VP mobile app in one embodiment of the VP. FIG. 3 provides an example of how a VP mobile app may be utilized during a purchase transaction. In FIG. 3, screen 301 shows that a customer who launches a merchant's (e.g., a gym's, a movie theater's, a store's) VP mobile app may be presented with a variety of options 303. For example, the customer may purchase an item (e.g., a soda, a movie ticket, a sweater) 305A, may update registration information (e.g., associated payment methods, contact information) 305B, may obtain information from the gym (e.g., helpful exercise tips) 305C, may obtain offers and/or coupons from the gym 305D, and/or the like.

Screen 310 shows that if the customer selects to purchase an item 305A, the customer may be prompted to provide information regarding the purchase transaction 313. For example, such information may include the amount associated with the purchase transaction (e.g., $1.50) 315A, the customer's PIN (e.g., used to authenticate the customer) 315B, and/or the like. The customer may submit such information by pressing a submit button 317.

Screen 320 shows that the gym's VP mobile app may contact a VP Server (e.g., via a network connection) to obtain a payment token for the purchase transaction 323. For example, the VP Server may send a QR code to the gym's VP mobile app.

Screen 330 shows an exemplary QR code that may be displayed by the gym's VP mobile app on the display of the customer's smartphone 333. The customer may transmit the QR code to the CED by holding the smartphone's screen in front of the CED's camera. Transmitting the QR code to the CED facilitates paying for the soda.

FIG. 4 shows a transaction processing data flow diagram in one embodiment of the VP. FIG. 4 provides an example of how data may flow to, through, and/or from the VP during transaction (e.g., purchase transaction) processing. In FIG. 4, a customer 402 may input transaction information 421 via a client 406 to obtain a payment token. The customer may use a peripheral device (e.g., a touchscreen, a keyboard, a mouse) of the client (e.g., a smartphone, a media player) to input the transaction information. For example, the transaction information may include data such as the customer's VP mobile app login information (e.g., to log into the VP mobile app), purchase amount (e.g., to make the purchase token valid for a specified purchase amount), PIN (e.g., to authorize payment token issuance), item information (e.g., to make the purchase token valid for specified items and/or categories of items), location (e.g., to make the payment token valid in a specified geographic location and/or in a specified store and/or chain of stores), and/or the like.

The client may send a payment token request 425 to a VP Server 410. For example, the payment token request may include data such as a user (e.g., customer) identifier, a VP mobile app identifier, a client identifier, a purchase amount, a PIN, item information, location, transaction date, transaction time, and/or the like. In one implementation, the payment token request may be in XML format substantially in the following form:

<XML>

<PaymentTokenRequest>

<UserID>ID_User1/UserID>
<ClientID>ID_Smartphone1</ClientID>
<AppID>ID_AppGYM</AppID>
<PurchaseAmount>$1.50</PurchaseAmount>
<PIN>1234</PIN>
<Location>40.7142° N, 74.0064° W</Location>

</PaymentTokenRequest>

</XML>

The VP Server may generate and send a payment token 429 to the client's VP mobile app. In various implementations, the payment token may be in the form of a QR code, a barcode, a PIN, an NFC token, an audio file, an image file, a video file, and/or the like.

The customer may use the client to provide a payment token output 433 to a CED 414 (e.g., a CED associated with a vending machine, a CED utilized by a merchant in a store, a CED utilized by a merchant at a fair). In some embodiments, instead of the CED, a merchant's POS system (e.g., with a barcode reader), a mobile device (e.g., with a camera and POS software), and/or the like may be utilized by the VP during transaction processing. In various implementations, the customer may provide the payment token to the CED by holding the smartphone's screen (e.g., displaying a QR code, a barcode, an image file, a video file) near the CED's camera, by entering a PIN displayed on the client's screen via the CED's keyboard, by playing back an audio file near the CED's microphone, by transmitting an NFC token to the CED's NFC reader, and/or the like.

The CED may send a payment request 437 to the VP Server. For example, the payment request may include data such as payment token data, a merchant identifier, a CED identifier, a CED location (e.g., geographic location, location within a store), data regarding the transaction (e.g., a transaction identifier, SKU level data regarding items being purchased by a customer, item quantities, item prices, total purchase amount, transaction date, transaction time), and/or the like. In one implementation, the payment request may be in XML format substantially in the following form:

<XML>

<PaymentRequest>

<PaymentToken>QR Code data</PaymentToken>
<MerchantID>ID_GYM</MerchantID>
<CED_ID>ID_CED1</CED_ID>
<TransactionDetails>

<TransactionID>ID_Transaction1</TransactionID>
<ItemID>ID_Item1</ItemID>
<ItemName>Soda</ItemName>
<PurchasePrice>$1.50</PurchasePrice>

</TransactionDetails>

</PaymentRequest>

</XML>

The VP Server may analyze payment details 439 to determine whether the payment request is valid and/or to determine the customer's payment method. For example, the VP Server may analyze data such as the user account associated with the payment token; a payment method associated with the user's account (e.g., a default payment method); the expiration date of the payment token; purchase amount, item information, location, and/or the like associated with the payment token and/or with the transaction; and/or the like.

The VP Server may send an authorization request 441 to a payment processor 418. The payment processor may be an entity that authorizes payment (e.g., based on correctness of provided information and/or fraud risk assessment). For example, the payment processor may be First Data Resources (FDR), Guardian Payment Systems (GPS), Smart Technology Solutions (STS), LevelUp, PayPal, and/or the like. In one implementation, the authorization request may be in XML format substantially in the following form:

<XML>

<AuthorizationRequest>

<TransactionID>ID_Transaction1</TransactionID>
<PurchaseAmount>$1.50</PurchaseAmount>
<MerchantDetails>GYM</MerchantDetails>
<Payment>

<PaymentType>ACH</PaymentType>
<AccountNumber>Account number</AccountNumber>

</Payment>

</AuthorizationRequest>

</XML>

The payment processor may send an authorization response 445 to the VP Server. The authorization response may include an indicator of whether a payment was authorized (e.g., authorized, denied), a request for additional information (e.g., a signature, a PIN, a password, a zip code), and/or the like. In one implementation, the authorization response may be in XML format substantially in the following form:

<XML>

<AuthorizationResponse>

<TransactionID>ID_Transaction1</TransactionID>
<TransactionStatus>Authorized</TransactionStatus>

</AuthorizationResponse>

</XML>

The VP Server may send a payment response 449 to the CED. The payment response may include an indicator of whether the payment was authorized (e.g., authorized, denied), a request for additional information (e.g., a signature, a PIN, a password, a zip code), additional information (e.g., a promotional message), and/or the like. In one implementation, the payment response may be in XML format substantially in the following form:

<XML>

<PaymentResponse>

<MerchantID>ID_GYM</MerchantID>
<CED_ID>ID_CED1</CED_ID>
<TransactionID>ID_Transaction1</TransactionID>
<TransactionStatus>Authorized</TransactionStatus>

</PaymentResponse>

</XML>

The CED may provide a transaction result output 453 to the customer. For example the transaction result output may be an indicator (e.g., via a display of the CED) of whether the transaction has been successfully completed (e.g., transaction approved, transaction failed), an informational message (e.g., a reminder to the customer to take the dispensed soda), a receipt, and/or the like.

FIG. 5 shows a logic flow diagram illustrating a VP mobile app transaction processing (MATP) component in one embodiment of the VP. In FIG. 5, a VP mobile app executing via a client may receive a purchase request at 505. In various implementations, the VP mobile app may be a mobile app (e.g., an iOS app, an Android app), a webpage, a plug-in, an applet, and/or the like. In some implementations, the VP mobile app may make use of a hosted VP webpage and/or app component to facilitate communication with the VP. The purchase request may be input by a user (e.g., a consumer) wishing to purchase an item (e.g., a soda, a personal training session, a movie ticket, a sweater). For example, the user may push a “Purchase an item” button of the VP mobile app.

A determination may be made at 510 whether to prompt the user for transaction data. In one embodiment, the VP mobile app may be configured to obtain a payment token without any information regarding the associated transaction. For example, this may facilitate ease of use of the VP mobile app. In another embodiment, the VP mobile app may be configured to obtain transaction information (e.g., purchase amount, item information, location) regarding the associated transaction. For example, this may facilitate stronger security when using the VP mobile app. In one implementation, a configuration file and/or a setting of the VP mobile app (e.g., specified by the customer, specified by the VP administrator) may be checked (e.g., via a C++ function call) to make this determination.

If it is determined that the user should be prompted for transaction data, the specified transaction data (e.g., purchase amount, item information, location) may be obtained from the user at 515. For example, the user may enter the transaction data via a GUI of the VP mobile app.

A determination may be made at 520 whether to prompt the user for authorization data. In one embodiment, the VP mobile app may be configured to obtain a payment token without authorization data. For example, this may facilitate ease of use of the VP mobile app. In another embodiment, the VP mobile app may be configured to obtain authorization data (e.g., a PIN that authorizes issuance of the payment token). For example, this may facilitate stronger security when using the VP mobile app. In one implementation, a configuration file and/or a setting of the VP mobile app may be checked to make this determination.

If it is determined that the user should be prompted for authorization data, the specified authorization data (e.g., a PIN) may be obtained from the user at 525. For example, the user may enter the transaction data via a GUI of the VP mobile app.

A payment token may be obtained from a VP Server at 530. For example, the VP mobile app may send a request to the VP Server to generate and send a payment token. This request may include obtained transaction data and/or authorization data. The payment token may be received in a response from the VP Server. In some implementations, a hosted VP webpage and/or app component may facilitate obtaining transaction data and/or authorization data, and/or communicating with the VP Server.

The payment token may be provided to a CED at 535. In various implementations, the client may provide the payment token to the CED by displaying the payment token on the screen, by playing back a payment token audio file, by transmitting the payment token via NFC, and/or the like.

FIG. 6 shows a logic flow diagram illustrating a server transaction processing (STP) component in one embodiment of the VP. For example, the STP component may be used to facilitate transaction processing by a VP Server. In FIG. 6, a payment token request may be received at 601. For example, the payment token request may be received from a customer's client via a network device.

A payment token may be generated at 605. In various implementations, the payment token may be a one-time use token; may expire after a specified period of time (e.g., after one hour); may be restricted for use at a specified merchant, at a specified location, for a specified amount, for a specified item, by a specified client, by a specified VP mobile app, by a specified user, and/or the like; may be generated contingent on receiving a predetermined PIN via the payment token request; and/or the like. In one embodiment, the payment token may be generated by creating an alphanumeric identifier (e.g., via a hash function that provides a hash value based on a customer identifier, request time, transaction data, and/or the like) and/or storing the alphanumeric identifier along with the associated conditions (e.g., expiration time, use restrictions). For example, the payment token may be stored via an entry in a payment tokens data store 930c.

The payment token may be sent to the client at 610. The payment token may be in a variety of formats such as a QR code, a barcode, a PIN, an NFC token, an audio file, an image file, a video file, and/or the like. In various implementations, the payment token may be sent as is, encrypted, compressed, and/or the like.

A payment request may be received from a CED at 615. For example, the payment request may be received from a CED associated with a vending machine from which the customer wishes to purchase a soda. In another example, the payment request may be received from a POS system of a store from which the customer wishes to purchase a sweater. In yet another example, the payment request may be received from a mobile device with POS software of a merchant from whom the customer wished to purchase food at a fair. The payment request may include a payment token.

A determination may be made at 620 whether the payment token included with the payment request is valid. In various implementations, this determination may be made by checking whether the payment token exists in the payment tokens data store, whether the payment token has not expired, whether use restrictions associated with the payment token are satisfied, and/or the like.

If the payment token is not valid, the transaction may be denied at 625. In one embodiment, an error code and/or an error message indicating the reason why the transaction has been denied may be specified. This information may be sent to the CED at 660 and may be used by the CED to help the customer rectify the problem.

If the payment token is valid, available payment methods may be determined at 630. In one embodiment, payment methods associated with the VP mobile app utilized by the consumer to request the payment token may be available. In another embodiment, payment methods associated with the consumer's VP account may be available. In one implementation, available payment methods may be determined by checking (e.g., via one or more SQL statements) a payment methods data store 930d. For example, the consumer's available payment methods may include ACH direct debit and a credit card.

A determination may be made at 635 whether a default payment method should be used. In one embodiment, this determination may be made based on whether the consumer specified a default payment method (e.g., for the VP mobile app, for the consumer's VP account). In another embodiment, this determination may be made based on whether the consumer has a single payment method, which may be considered a default payment method.

If it is determined that a default payment method should be used, the default payment method may be utilized as the payment method for the transaction. Otherwise, the payment method for the transaction may be obtained via the CED at 640. For example, the CED may be provided with available payment methods and may be charged with obtaining a payment method selection (e.g., ACH direct debit) from the consumer.

A determination may be made at 645 whether payment via the payment method is authorized. For example, the VP Server may contact a payment processor and request that the payment processor authorize the payment. In another example, the VP Server may be capable of authorizing the payment on its own. In some implementations, additional data (e.g., a signature for a credit card, a PIN for a debit card) may be desired, and the payment may be authorized upon obtaining such additional data via the CED.

If the payment is authorized, the transaction may be authorized at 650. In one embodiment, a success code may be specified and/or additional information (e.g., coupons, advertisements) may be provided. Such data may be sent to the CED at 660 and may be used by the CED to facilitate the transaction.

FIG. 7 shows a logic flow diagram illustrating a CED transaction processing (CTP) component in one embodiment of the VP. For example, the CTP component may be used to facilitate transaction processing by a CED. In some embodiments, instead of the CED, a merchant's POS system (e.g., with a barcode reader), a mobile device (e.g., with a camera and POS software), and/or the like may be utilized by the VP during transaction processing. In FIG. 7, a payment token may be obtained from a user (e.g., a consumer) at 705. For example, the consumer may initiate a transaction to purchase a soda from a vending machine associated with the CED, and may provide the payment token to pay for the soda. In another example, the consumer may initiate a transaction to purchase a sweater from a merchant, and may provide the payment token to the merchant's CED to pay for the sweater. The CED may obtain the payment token via a peripheral device (e.g., a camera, a keyboard, a touchscreen, a microphone, an NFC reader).

A payment request may be sent (e.g., via a network device) to a VP Server at 710. The payment request may instruct the VP Server to obtain payment based on payment token data, merchant data, CED data, transaction data, and/or the like.

A determination may be made at 715 whether to obtain a payment method selection. For example, if multiple payment methods (e.g., ACH direct debit and a credit card) are available to the user and/or if a default payment method has not been specified, the VP Server may provide the CED with the available payment methods and may instruct the CED to obtain a payment method selection from the user.

If a payment method selection should be obtained, the user may be prompted to provide a payment method selection at 720. For example, the CED may display the available payment methods and may instruct the user to select a payment method (e.g., ACH direct debit) via a touchscreen. In some implementations, the consumer may be steered toward selecting a more preferable (e.g., based on having the lowest transaction cost, based on branding, based on tracking and/or reporting capabilities) payment method in a variety of ways (e.g., more preferable payment methods may be shown first and/or in a more visually appealing manner, the most preferable method may be shown as selected). In some implementations, the consumer may utilize a plurality of payment methods (e.g., a coupon and ACH direct debit, a gift card and a credit card). Information regarding the user's payment method selection may be sent to the VP Server at 725.

A payment response may be obtained from the VP Server at 730. For example, the payment response may indicate whether the transaction has been authorized, may include additional information (e.g., coupons, advertisements), and/or the like.

A determination may be made at 740 whether the transaction has been authorized. In various implementations, this determination may be made based on an error code, a success code, a transaction status field, and/or the like of the payment response (e.g., via an XML parser). If the transaction has been denied the user may be informed at 745. For example, the CED may display an informational message (e.g., explaining why the transaction has been denied) and/or may allow the user to rectify the problem. If the transaction has been authorized, the CED may facilitate the transaction at 750. For example, the CED may instruct the vending machine to dispense the soda and/or may display an informational message (e.g., reminding the customer to take the dispensed soda, showing an advertisement). In another example, the CED may inform the merchant that the transaction has been approved.

FIG. 8 shows a logic flow diagram illustrating an app registration (AR) component in one embodiment of the VP. In FIG. 8, an app registration request may be received at 805. For example, a user may wish to register for a VP mobile app of a merchant (e.g., a gym, a clothing store). Accordingly, the user may have downloaded the VP mobile app (e.g., from an app store) and may have initiated registration via the VP mobile app.

A determination may be made at 810 whether access to VP registration information is available. VP registration information may include user details such as the user's name, address, payment methods (e.g., credit cards, gift cards, PayPal account) and associated details (e.g., stored in the payment methods data store 930d), a default payment method, payment method preference order, and/or the like. For example, the VP registration information may have been obtained when the user registered with the VP (e.g., by registering via an associated website and/or app), when the user registered with another VP mobile app, and/or the like. In one embodiment, the VP mobile app may be configured to have access to shared VP data (e.g., data shared by the merchant associated with the VP mobile app, data shared by other merchants associated with the VP, data shared by the VP). For example, the merchant may wish the VP mobile app to have access to registration information shared among the merchant's stores and/or chains of stores. In another embodiment, the VP mobile app may be configured not to have access to shared VP data. For example, the merchant may wish the VP mobile app to obtain registration information specific to the VP mobile app. In one implementation, a configuration file and/or a setting of the VP mobile app may be checked to make this determination.

If it is determined that the VP mobile app has access to VP registration information, the user may be prompted to provide access to the VP registration information at 815. For example, the user may be prompted to provide login credentials (e.g., username and password) to the user's VP account.

A determination may be made at 820 whether the user provides access to VP registration information. If the user provides such access (e.g., by providing login credentials to the user's VP account), VP registration information may be associated with the VP mobile app at 825. For example, the VP mobile app may be able to utilize the user's name, address (e.g., billing address, shipping address), payment methods, and/or the like associated with the user's VP account.

A determination may be made at 830 whether additional registration information should be obtained from the user. For example, this determination may be made by asking the user whether the user wishes to provide additional registration information (e.g., an additional payment method).

If the user wishes to provide additional registration information or if access to VP registration information is not available and/or not provided, app registration information may be obtained at 835. For example, the user may be prompted to provide user details such as the user's name, address, payment methods (e.g., credit cards, gift cards, PayPal account) and associated details (e.g., stored in the payment methods data store 930d), a default payment method, payment method preference order, and/or the like.

App registration information access level may be determined at 840. For example, the app registration information access level may specify who has access to the app registration information (e.g., whether the app registration information is specific to the VP mobile app, shared with other VP mobile apps associated with the merchant, shared with the VP). In one embodiment, the app registration information access level may be specified by the merchant. In another embodiment, the app registration information access level may be specified by the user. The app registration information may be associated with appropriate entities based on the access level at 845. For example, if the user wishes to share a newly provided payment method with the VP, VP mobile apps utilized by the user may gain access to the newly provided payment method.

FIG. 10 illustrates additional exemplary embodiments of the VP.

### Detailed Description of the VP Coordinator

FIG. 9 shows a block diagram illustrating an exemplary VP coordinator in one embodiment of the VP. The VP coordinator facilitates the operation of the VP via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the VP coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the VP coordinator may comprise a standalone computer system, a distributed computer system, a node in a computer network (i.e., a network of computer systems organized in a topology), a network of VP coordinators, and/or the like. It is to be understood that the VP coordinator and/or the various VP coordinator elements (e.g., processor, system bus, memory, input/output devices) may be organized in any number of ways (i.e., using any number and configuration of computer systems, computer networks, nodes, VP coordinator elements, and/or the like) to facilitate VP operation. Furthermore, it is to be understood that the various VP coordinator computer systems, VP coordinator computer networks, VP coordinator nodes, VP coordinator elements, and/or the like may communicate among each other in any number of ways to facilitate VP operation. As used in this disclosure, the term “user” refers generally to people and/or computer systems that interact with the VP; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The VP coordinator includes a processor 901 that executes program instructions (e.g., VP program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 905 via a system bus 903. The system bus may interconnect these and/or other elements of the VP coordinator via electrical, electronic, optical, wireless, and/or the like communication links (e.g., the system bus may be integrated into a motherboard that interconnects VP coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., VP program instructions) executed by the processor. The system memory may facilitate accessing, storing, retrieving, modifying, deleting, and/or the like data (e.g., VP data) by the processor.

In various embodiments, input/output devices 910 may be connected to the processor and/or to the system memory, and/or to one another via the system bus.

In some embodiments, the input/output devices may include one or more graphics devices 911. The processor may make use of the one or more graphic devices in accordance with program instructions (e.g., VP program instructions) executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., VP data). A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 913. The processor may make use of the one or more audio devices in accordance with program instructions (e.g., VP program instructions) executed by the processor. In one implementation, an audio device may be a sound card that may obtain (e.g., via a connected microphone), process, output (e.g., via connected speakers), and/or the like audio data (e.g., VP data). A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC′97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 915. The processor may make use of the one or more network devices in accordance with program instructions (e.g., VP program instructions) executed by the processor. In one implementation, a network device may be a network card that may obtain (e.g., via a Category 5 Ethernet cable), process, output (e.g., via a wireless antenna), and/or the like network data (e.g., VP data). A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 917. The processor may make use of the one or more peripheral devices in accordance with program instructions (e.g., VP program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the VP coordinator with a variety of input, output and processing capabilities.

In some embodiments, the input/output devices may include one or more storage devices 919. The processor may access, read from, write to, store in, erase, modify, and/or the like a storage device in accordance with program instructions (e.g., VP program instructions) executed by the processor. A storage device may facilitate accessing, storing, retrieving, modifying, deleting, and/or the like data (e.g., VP data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 905 and the one or more storage devices 919 may be referred to as memory 920 (i.e., physical memory).

VP memory 920 contains processor-operable (e.g., accessible) VP data stores 930. Data stores 930 comprise data that may be used (e.g., by the VP) via the VP coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, VP coordinator elements, and/or the like) to facilitate VP operation. For example, VP data stores may comprise data stores 930a-d implemented as one or more databases. A users data store 930a may be a collection of database tables that include fields such as UserID, UserName, UserPreferences, and/or the like. A clients data store 930b may be a collection of database tables that include fields such as ClientID, ClientName, ClientDeviceType, ClientScreenResolution, and/or the like. A payment tokens data store 930c may be a collection of database tables that include fields such as PaymentTokenID, PaymentTokenAmount, PaymentTokenExpirationDateTime, PaymentTokenUseRestrictions, and/or the like. A payment methods data store 930d may be a collection of database tables that include fields such as PaymentMethodID, PaymentMethodName, PaymentMethodAccountNumber, PaymentMethodFees, PaymentMethodPreferenceOrder, IsDefault, and/or the like. The VP coordinator may use data stores 930 to keep track of inputs, parameters, settings, variables, records, outputs, and/or the like.

VP memory 920 contains processor-operable (e.g., executable) VP components 940. Components 940 comprise program components (including program instructions and any associated data stores) that are executed (e.g., by the VP) via the VP coordinator (i.e., via the processor) to transform VP inputs into VP outputs. It is to be understood that the various components and their subcomponents, capabilities, applications, and/or the like may be organized in any number of ways (i.e., using any number and configuration of components, subcomponents, capabilities, applications, VP coordinator elements, and/or the like) to facilitate VP operation. Furthermore, it is to be understood that the various components and their subcomponents, capabilities, applications, and/or the like may communicate among each other in any number of ways to facilitate VP operation. For example, the various components and their subcomponents, capabilities, applications, and/or the like may be combined, integrated, consolidated, split up, distributed, and/or the like in any number of ways to facilitate VP operation. In another example, a single or multiple instances of the various components and their subcomponents, capabilities, applications, and/or the like may be instantiated on each of a single VP coordinator node, across multiple VP coordinator nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 940 may include an operating environment component 940a. The operating environment component may facilitate operation of the VP via various subcomponents.

In some implementations, the operating environment component may include an operating system subcomponent. The operating system subcomponent may provide an abstraction layer that facilitates the use of, communication among, common services for, interaction with, security of, and/or the like of various VP coordinator elements, components, data stores, and/or the like.

In some embodiments, the operating system subcomponent may facilitate execution of program instructions (e.g., VP program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the VP. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the VP coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the VP coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the VP by providing user interface elements that may be used by the VP to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate VP capabilities such as storage, analysis, retrieval, access, modification, deletion, aggregation, generation, and/or the like of data (e.g., the use of data stores 930). The database subcomponent may make use of database languages (e.g., Structured Query Language (SQL), XQuery), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, and/or the like.

In some implementations, the operating environment component may include an information handling subcomponent. The information handling subcomponent may provide the VP with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, VP components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 930) via the database subcomponent.

In some embodiments, the information handling subcomponent may facilitate presentation of information obtained from users, VP components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate VP message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate VP message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates VP security. In some embodiments, the security subcomponent may restrict access to the VP, to one or more services provided by the VP, to data associated with the VP (e.g., stored in data stores 930), to communication messages associated with the VP, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the VP may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates VP virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 940 may include a user interface component 940b. The user interface component may facilitate user interaction with the VP by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 940 may include any of the components MATP 940c, STP 940d, CTP 940e, AR 940f described in more detail in preceding figures.

### The Embodiments of the VP

The entirety of this disclosure (including the written description, figures, claims, abstract, appendices, and/or the like) for VAULT PLATFORM METHODS, APPARATUSES AND MEDIA shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the VP coordinator, VP coordinator elements, VP data stores, VP components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the VP coordinator, VP coordinator elements, VP data stores, VP components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the VP discussed in this disclosure have been directed to purchasing items from a vending machine in a gym, the innovations described in this disclosure may be readily applied to a wide variety of other fields and/or applications.

The following is claimed:

1. A processor-implemented payment collection method, comprising:
prompting via a processor a customer to provide payment information for a purchase request;
obtaining via the processor a payment token associated with the purchase request from the customer;
sending via the processor a payment request including the payment token for payment processing; and
receiving via the processor a payment confirmation based on successful authorization of payment via a payment method associated with the payment token.

2. The method of claim 1, wherein the payment token is one of a QR code, a PIN, a sound, an NFC token.

3. The method of claim 1, wherein the payment token is obtained via the customer's client.

4. The method of claim 1, wherein the payment token is obtained by facilitating text entry by the customer via a keyboard.

5. The method of claim 1, wherein the payment token is a one-time use expiring token.

6. The method of claim 1, wherein the payment token is restricted for use by one or more of the following conditions: at a specified merchant, at a specified location, for a specified purchase amount, for a specified item, by a specified client, by a specified mobile app, by a specified customer.

7. The method of claim 1, further comprising:
obtaining a plurality of payment methods associated with the payment token in response to the payment request; and
prompting the customer to select at least one of the plurality of payment methods.

8. The method of claim 1, further comprising authorizing a vending machine to dispense an item associated with the purchase request.

9. A processor-implemented payment collection method, comprising:
obtaining via a processor a payment token request from a customer's client;
generating via the processor a payment token associated with the customer's account;
sending via the processor the payment token to the customer's client;
obtaining via the processor a payment request including the payment token from a consumer engagement device;
retrieving via the processor payment information associated with the customer's account based on the payment token;
authorizing via the processor payment for the payment request using the retrieved payment information; and
sending via the processor a payment confirmation to the consumer engagement device based on the authorization.

10. The method of claim 9, wherein the retrieved payment information is associated with a default payment method.

11. The method of claim 9, wherein the retrieved payment information is associated with a customer-selected payment method.

12. The method of claim 9, further comprising verifying that the payment token obtained with the payment request is valid.
